(19) United States
(12) Patent Application Publication
(10) Pub. No.: US 2025/0239246 A1
(43) Pub. Date: Jul. 24, 2025

(54) METHOD, APPARATUS, DEVICE, AND STORAGE MEDIUM FOR AUDIO PROCESSING

(71) Applicants: Beijing Zitiao Network Technology Co., Ltd., Beijing (CN); Lemon Inc., Grand Cayman (KY)

(72) Inventors: Shuting CHU, Beijing (CN); Mingfei CAI, Los Angeles, CA (US)

(21) Appl. No.: 18/935,163

(22) Filed: Nov. 1, 2024

(30) Foreign Application Priority Data
Jan. 19, 2024 (CN) 202410084545.9

(51) Int. Cl. G10H 5/00

(52) U.S. Cl. CPC G10H 5/005; G10H 2220/116

(57) ABSTRACT

Embodiments of the disclosure relate to a method, apparatus, device, and storage medium for audio processing. The method provided herein includes: obtaining a first media content input by a user, the first media content including a first audio content corresponding to a singing content; and providing a second media content based on a selection of a target timbre by the user, the second media content including a second audio content corresponding to the singing content, and the second audio content corresponding to the selected target timbre. In this way, the embodiments of the disclosure can convert the first audio content in the audio corresponding to the singing content into a specified timbre, thereby improving the voice changing effect while retaining the timbre.

### CROSS-REFERENCE

This application claims the benefit of Chinese Patent Application No. 202410084545.9 filed on Jan. 19, 2024, entitled “METHOD, APPARATUS, DEVICE, AND STORAGE MEDIUM FOR AUDIO PROCESSING”, which is hereby incorporated by reference in its entirety.

### FIELD

Example embodiments of the present disclosure generally relate to the field of computers, and more particularly, to a method, apparatus, device and computer-readable storage medium for audio processing.

### BACKGROUND

With the development of computer technologies, the Internet has become an important platform for people's information interaction. During the process of people performing information interaction through the Internet, various types of audios have become important media for people to perform social expressions and exchange information. Therefore, it is expected to implement a voice changing technology in a singing scenario by processing audio.

### SUMMARY

In a first aspect of the present disclosure, a method of audio processing is provided. The method comprises: obtaining a first media content input by a user, the first media content comprising a first audio content corresponding to a singing content; and providing a second media content based on a selection of a target timbre by the user, the second media content comprising a second audio content corresponding to the singing content, the second audio content corresponding to the selected target timbre.

In a second aspect of the present disclosure, an apparatus for audio processing is provided. The apparatus comprises: an obtaining module configured to obtain a first media content input by a user, the first media content comprising a first audio content corresponding to a singing content; and a providing module configured to provide a second media content based on a selection of a target timbre by the user, the second media content comprising a second audio content corresponding to the singing content, and the second audio content corresponding to the selected target timbre.

In a third aspect of the present disclosure, there is provided an electronic device, the device comprising at least one processing unit; and at least one memory coupled to the at least one processing unit and storing instructions for execution by the at least one processing unit. The instructions, when executed by the at least one processing unit, cause an apparatus to perform the method of the first aspect.

In a fourth aspect of the present disclosure, a computer readable storage medium is provided, where the computer readable storage medium stores a computer program, and the computer program is executable by a processor to implement the method of the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which the embodiments according to the present disclosure can be implemented;

FIG. 2 illustrates a flowchart of an example process for audio processing according to some embodiments of the disclosure;

FIGS. 3A-3C illustrate schematic diagrams of example interfaces according to some embodiments of the present disclosure;

FIG. 4 illustrates a schematic structural block diagram of an example apparatus for audio processing according to some embodiments of the disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user, all following respective legal regulations and related regulations. In embodiments of the present disclosure, all data collection, acquisition, processing, processing, forwarding, use, and the like, are made with user knowledge and confirmation. Accordingly, when implementing the embodiments of the present disclosure, the user should be informed of the types of data or information that may be involved, a usage range, a usage scene, and the like in an appropriate manner according to relevant legal regulations, and the authorization of the user is obtained. The specific informing and/or authorization manner may vary according to actual situations and application scenes, and the scope of the present disclosure is not limited in this aspect.

In the present description and the embodiments, solutions, if personal information processing is involved, are performed on the basis of legitimacy (for example, the consent of the personal information body is obtained, or necessary for fulfillment of a contract, etc.), and is performed only within a specified range or an agreed range. The user rejects personal information other than the necessary information required for processing the basic function, and the use of the basic function by the user is not affected.

In the process of people interacting information through the Internet, people expect to use a high-quality audio processing method to conveniently achieve a desired voice changing effect. A traditional audio processing method performs voice changing by means of a voice changer. However, the voice changer can only change the timbre of a speaker in a spoken scenario. If the audio of the human voice singing is input, the voice conversion effect cannot restore the input singing tone, and the output will still be the orally played content.

In view of this, embodiments of the present disclosure provide an audio processing solution. According to the solution, first audio content corresponding to singing content in audio can be converted into a specified timbre. The specified timbre is an existing timbre in a sound library or a timbre which is authorized to be used, thereby improving a voice changing effect on the basis of retaining the timbre. For example, the user may be able to hear, at a low cost, what effect of his or her own singing voice would be when sung in a timbre with another characteristic.

Various example implementations of the solution are described in further detail below with reference to the accompanying drawings.

### Example Environment

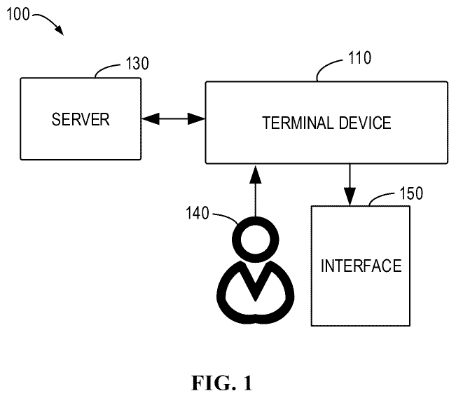

FIG. 1 illustrates a schematic diagram of an example environment 100 in which embodiments of the present disclosure can be implemented. As shown in FIG. 1, the example environment 100 can include a terminal device 110.

In this example environment 100, a terminal device 110 may run a platform that supports processing of audio. For example, voice changing may be performed on audios. The user 140 may interact with the platform via the terminal device 110 and/or attached devices thereof.

In the environment 100 of FIG. 1, if the platform is active, the terminal device 110 may present an interface 150 through the platform to support interface interaction.

In some embodiments, the terminal device 110 communicates with the server 130 to enable provision of services to the platform. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System (PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. In some embodiments, the terminal device 110 can also support any type of interface to a user (such as ‘wearable’ circuitry, etc.).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the application 120 supporting the virtual scene in the terminal device 110.

A communication connection may be established between the server 130 and the terminal device 110. The communication connection may be established in a wired manner or a wireless manner. The communication connection may include, but are not limited to, Bluetooth connections, mobile network connections. Universal Serial Bus (USB) connections, Wireless Fidelity (WIFI) connections, and the like, and the embodiments of the present disclosure are not limited in this regard. In an embodiment of the present disclosure, the server 130 and the terminal device 110 may achieve signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below with continued reference to the accompanying drawings.

### Example Processes

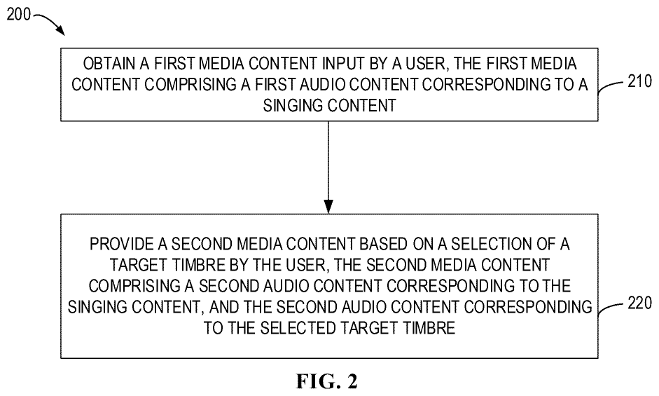

FIG. 2 illustrates a flowchart of an example audio processing process 200 according to some embodiments of the present disclosure. The process 200 can be implemented at the terminal device 110. The process 200 is described below with reference to FIG. 1.

As shown in FIG. 2, at block 210, the terminal device 110 obtains a first media content input by the user 140, where the first media content includes a first audio content that corresponds to a singing content.

In some embodiments, the first media content that is obtained by the terminal device 110 and input by the user 140 may be the first media content recorded by the user 140. For example, a user shoots a piece of video or records a piece of voice as the first media content. The first media content includes a segment of audio corresponding to the singing content. For example, a segment of video shot by the user includes a song sung by the user.

In some embodiments, the first media content that is obtained by the terminal device 110 and input by the user 140 may be first media content uploaded by the user 140. For example, a previous segment of video stored on the terminal device 110, or a previously recorded segment of voice stored may be utilized as the first media element.

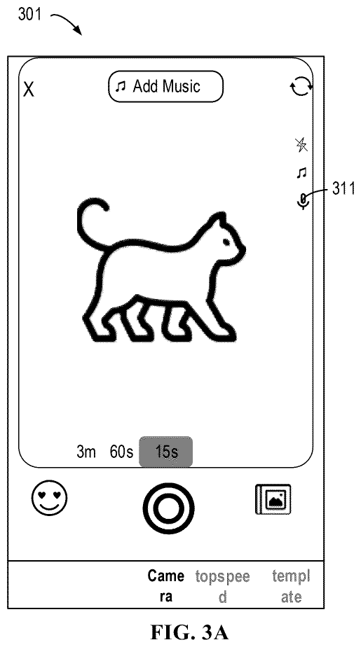

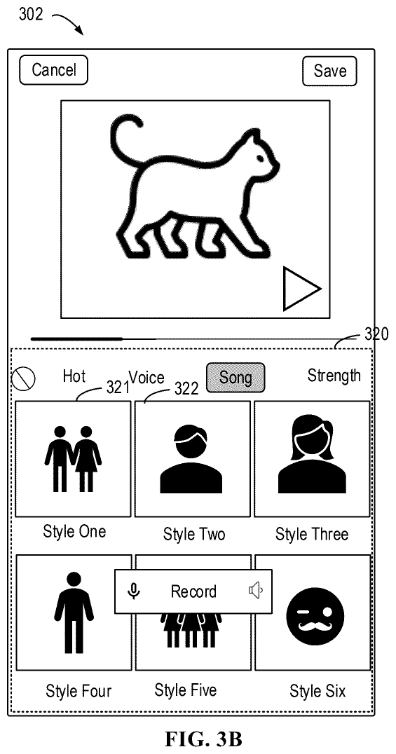

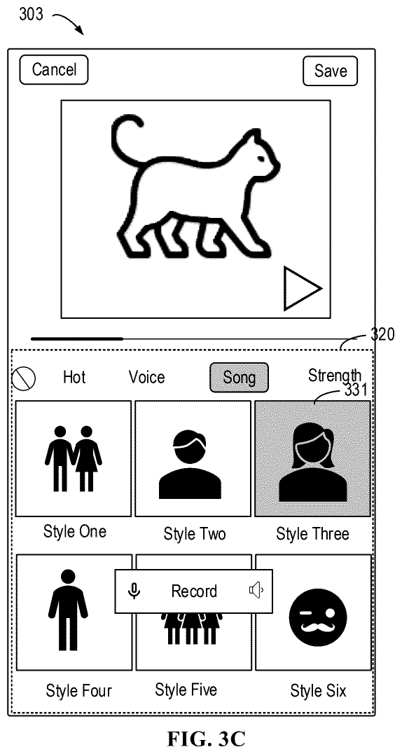

The process 200 will be described below with reference to FIGS. 3A-3C. FIGS. 3A-3C illustrate schematic diagrams of example interfaces 301-303 according to some embodiments of the present disclosure. The interfaces 301 to 303 may, for example, be provided by the terminal device 110 shown in FIG. 1.

As shown in FIG. 3A, the terminal device 110 obtains a segment of video recorded by the user 140 on a shooting page, where the video includes first audio content corresponding to singing content. The user 140 then clicks a voice control 311 in the interface 301.

The terminal device 110 presents a selection panel 320 based on the click of the user 140. As shown in FIG. 3B, the interface 301 may be, for example, a conversation interface for a conversation. The terminal device 110 may display the selection panel 320 in interface 301. As an example, the selection panel 320 may display different styles of timbre, e. g., style one 321, style two 322, style three, etc.

In some embodiments, the selection panel 320 displayed by the terminal device 110 may provide a first set of candidate effects for processing the speaking content. For example, the terminal device 110 obtains the speaking content (for example, an oral broadcasting) input by the user, and the selection panel 320 may provide different styles that can be converted in response to the speaking content.

In some embodiments, the selection panel 320 displayed by the terminal device 110 may also provide a second set of candidate effects for processing the singing content. For example, the terminal device 110 obtains the singing content input by the user, and the selection panel 320 may provide different styles that can be converted while retaining its original tone, tempo, and so forth, in response to the input singing content.

In some embodiments, the terminal device 110 receives a user selection of a target effect in the second set of candidate effects, the target effect corresponding to a target timbre. For example, the terminal device 110 may receive a different timbre for a different gender, or a different timbre corresponding to a different age in the second set of candidate effects selected by the user.

With continued reference to FIG. 2, at block 220, the terminal device 110 provides second media content based on a selection of a target timbre by the user 140. In some embodiments, the second media content includes second audio content that corresponds to singing content, the second audio content corresponding to the selected target timbre.

In some embodiments, the second audio content included in the second media content provided by terminal device 110 retains at least the target audio attribute of the first audio content. The target audio attributes include at least a tone, a cadence, etc. For example, if the tones of the first audio content include tone A and tone B, the second audio content retains at least the tone A and tone B.

Using FIG. 3C as an example, the user 140 selects style three 331 on the timbre selection panel 320 as the target timbre. The terminal device 110 receives a selection from the user 140 and converts the first audio content in the first media content to second audio content in the second media content. For example, the voice changing is performed on the voice of the song in the video uploaded by the user.

For example, if the terminal device 110 obtains the speaking content input by the user, the terminal device 110 may change the speaking content of different styles. For another example, if the terminal device 110 obtains singing content input by the user, singing content of different styles may be changed while a tone, a tempo, and the like of original singing are retained. The terminal device 110 calls the server 130 to convert the first audio content and provide the second audio content, based on the selection of the target effect by the user.

If the terminal device 110 obtains the first audio content corresponding to the singing included in the first media content, the terminal device 110 converts the first audio content into the second audio content by calling the server 130 based on the target timbre selected by the user, and provides the second audio content to the user. In this manner, the second audio content can include the tone of the input first audio. It can be understood that, in this manner, the user can hear, at a low cost, what effect of his or her own singing voice would be when sung in a timbre with another characteristic.

Generation of the second audio content is described below. In some embodiments, the terminal device 110 extracts the first audio content corresponding to the singing content from the first media content. Then, the terminal device 110 inputs the first audio content into a target model to obtain the second audio content. In some embodiments, the target model may be a model that is trained by the server according to sample data corresponding to the target timbre.

In some embodiments, the terminal device 110 extracts background audio content from the first media content. The background audio content is different from the first audio content, and the background audio content corresponds to the accompaniment content. For example, for a piece of video, the background audio content may be background music of the video. For the piece of video, the first audio content may be a song sung by the user himself. The terminal device 110 generates the second media content by fusing the second audio content and the background audio content.

In some embodiments, the terminal device 110 obtains intermediate audio content by fusing the second audio content and the background audio content. For the intermediate audio content, the terminal device 110 adjusts a reverberation effect or volume level of the intermediate audio content. In some examples, adjusting the volume of the intermediate audio content includes performing global volume equalization on the intermediate audio content. The terminal device 110 generates second media content according to the adjusted intermediate audio content.

In some embodiments, the terminal device 110 may first determine a reverberation parameter according to the first media content, and then the terminal device 110 adjusts the reverberation effect of the intermediate audio content according to the reverberation parameter.

For example, a reverberant matching model and a support vector classifier (SVC) model are models that need to be engineered in the entire link, and input and output of the two are independent and can be performed in parallel. The reverberant matching module is a very lightweight convolutional neural network (CNN) and a long short-term memory network (LSTM) module, which generally runs out before the support vector classifier SVC model. The reverberant matching model is only responsible for counting reverberating parameters from the original user vocals (the output is three scalar), and the actual addition of the audio reverberant is completed by the CPU in the last step before the link is output. The biggest difference between the overall link and the VC link should be the logic for reverberation matching and volume equalization, as well as the robust model extractor RMVPE f0 extractor for high pitch estimation in additional intermodulation music.

In the embodiments of the present disclosure, a first media content input by a user is obtained, the first media content including first audio content corresponding to singing content; and second media content is provided based on the selection of the target timbre by user, the second media content including second audio content corresponding to the singing content, the second audio content corresponding to the selected target timbre. In this way, in the embodiments of the present disclosure, the first audio content corresponding to the singing content in the audio can be converted into the specified tone, thereby improving the voice changing effect while retaining the timbre.

### Example Apparatus and Device

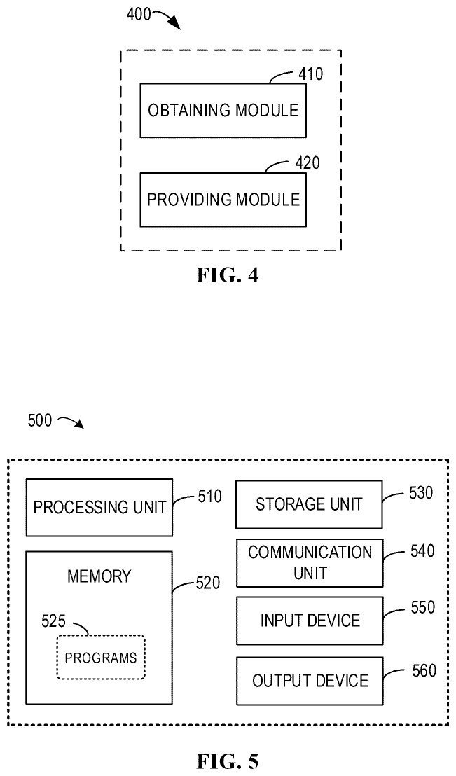

Embodiments of the present disclosure also provide corresponding apparatus for implementing the methods or processes described above. FIG. 4 illustrates a schematic structural block diagram of an example audio processing apparatus 400 according to certain embodiments of the present disclosure. The apparatus 400 may be implemented as or included in a terminal device 110. The various modules/components in the apparatus 400 may be implemented by hardware, software, firmware, or any combination thereof.

As shown in FIG. 4, the apparatus 400 includes an obtaining module 410 configured to obtain a first media content input by a user, the first media content including a first audio content corresponding to a singing content.

The apparatus 400 also includes a providing module 420 configured to provide a second media content based on a selection of a target timbre by the user, the second media content including a second audio content corresponding to the singing content, and the second audio content corresponds to the selected target timbre.

In some embodiments, at least a target audio attribute of the first audio content is retained in the second audio content, the target audio attribute including at least one of: tone, cadence.

In some embodiments, the providing module 420 further includes a selection module configured to display a selection panel, wherein the selection panel provides at least a first set of candidate effects for processing speaking content and a second set of candidate effects for processing singing content; and receive a selection of a target effect in the second set of candidate effects by the user, the target effect corresponding to the target timbre.

In some embodiments, the obtaining module 410 is further configured to obtain the first media content recorded by the user; obtain the first media content uploaded by the user.

In some embodiments, the providing module 420 further includes a generating module configured to extract, from the first media content, the first audio content corresponding to the singing content; and processing the first audio content by using a target model to generate the second audio content, wherein the target model is trained based on sample data corresponding to the target timbre.

In some embodiments, the generating module is further configured to extract background audio content from the first media content, the background audio content being different than the first audio content; and generate the second media content by fusing the second audio content and the background audio content.

In some embodiments, the background audio content corresponds to accompaniment content.

In some embodiments, the generating module is further configured to fuse the second audio content and the background audio content to obtain intermediate audio content; adjust a reverberation effect or volume level of the intermediate audio content; and generate the second media content based on the adjusted intermediate audio content.

In some embodiments, the providing module 420 further includes an adjusting module configured to determine a reverberation parameter based on the first media content; and adjust the reverberation effect of the intermediate audio content based on the reverberation parameter.

In some embodiments, the adjusting module is further configured to perform global volume equalization on the intermediate audio content.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the terminal device 110 of FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be a real or virtual processor and may be capable of performing various processes according to programs stored in the memory 520. In a multiprocessor system, a plurality of processing units executes computer executable instructions in parallel to improve the parallel processing capability of the electronic device 500.

The electronic device 500 typically includes a number of computer storage media. Such media may be any available media that are accessible by electronic device 500, including, but not limited to, volatile and non-volatile media, removable and non-removable media. The memory 520 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data and that can be accessed within the electronic device 500.

The electronic device 500 may further include additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method of audio processing, comprising:
obtaining a first media content input by a user, the first media content comprising a first audio content corresponding to a singing content; and
providing a second media content based on a selection of a target timbre by the user, the second media content comprising a second audio content corresponding to the singing content, and the second audio content corresponding to the selected target timbre.

2. The method of claim 1, wherein at least a target audio attribute of the first audio content is retained in the second audio content, the target audio attribute comprising at least one of: tone, cadence.

3. The method of claim 1, further comprising:
displaying a selection panel providing at least a first set of candidate effects for processing a speaking content and a second set of candidate effects for processing a singing content; and
receiving a selection of a target effect in the second set of candidate effects by the user, the target effect corresponding to the target timbre.

4. The method according to claim 1, wherein obtaining the first media content input by the user comprises at least one of:
obtaining the first media content recorded by the user, or
obtaining the first media content uploaded by the user.

5. The method of claim 1, wherein the second audio content is generated by:
extracting, from the first media content, the first audio content corresponding to the singing content; and
processing the first audio content by using a target model to generate the second audio content, wherein the target model is trained based on sample data corresponding to the target timbre.

6. The method of claim 5, wherein the second media content is generated by:
extracting, from the first media content, a background audio content different than the first audio content; and
generating the second media content by fusing the second audio content and the background audio content.

7. The method of claim 6, wherein the background audio content corresponds to an accompaniment content.

8. The method of claim 6, wherein generating the second media content by fusing the second audio content and the background audio content comprises:
fusing the second audio content and the background audio content to obtain an intermediate audio content;
adjusting a reverberation effect or volume level of the intermediate audio content; and
generating the second media content based on the adjusted intermediate audio content.

9. The method of claim 8, wherein adjusting the reverberation effect of the intermediate audio content comprises:
determining a reverberation parameter based on the first media content; and
adjusting the reverberation effect of the intermediate audio content based on the reverberation parameter.

10. The method of claim 8, wherein adjusting the volume level of the intermediate audio content comprises:
performing global volume equalization on the intermediate audio content.

11. An electronic device, comprising:
at least one processing unit; and
at least one memory coupled to the at least one processing unit and storing instructions for execution by the at least one processing unit, the instructions, when executed by the at least one processing unit, causing the electronic device to perform acts for audio processing, the acts comprising:
obtaining a first media content input by a user, the first media content comprising a first audio content corresponding to a singing content; and
providing a second media content based on a selection of a target timbre by the user, the second media content comprising a second audio content corresponding to the singing content, and the second audio content corresponding to the selected target timbre.

12. The device of claim 11, wherein at least a target audio attribute of the first audio content is retained in the second audio content, the target audio attribute comprising at least one of: tone, cadence.

13. The device of claim 11, wherein the acts further comprise:
displaying a selection panel providing at least a first set of candidate effects for processing a speaking content and a second set of candidate effects for processing a singing content; and
receiving a selection of a target effect in the second set of candidate effects by the user, the target effect corresponding to the target timbre.

14. The device according to claim 11, wherein obtaining the first media content input by the user comprises at least one of:
obtaining the first media content recorded by the user, or
obtaining the first media content uploaded by the user.

15. The device of claim 11, wherein the second audio content is generated by:
extracting, from the first media content, the first audio content corresponding to the singing content; and
processing the first audio content by using a target model to generate the second audio content, wherein the target model is trained based on sample data corresponding to the target timbre.

16. The device of claim 15, wherein the second media content is generated by:
extracting, from the first media content, a background audio content different than the first audio content; and
generating the second media content by fusing the second audio content and the background audio content.

17. The device of claim 16, wherein the background audio content corresponds to an accompaniment content.

18. The device of claim 16, wherein generating the second media content by fusing the second audio content and the background audio content comprises:
fusing the second audio content and the background audio content to obtain an intermediate audio content;
adjusting a reverberation effect or volume level of the intermediate audio content; and
generating the second media content based on the adjusted intermediate audio content.

19. The device of claim 18, wherein adjusting the reverberation effect of the intermediate audio content comprises:
determining a reverberation parameter based on the first media content; and
adjusting the reverberation effect of the intermediate audio content based on the reverberation parameter.

20. A computer readable storage medium, on which a computer program is stored, wherein the computer program is executable by a processor to implement a method of audio processing, comprising:
obtaining a first media content input by a user, the first media content comprising a first audio content corresponding to a singing content; and
providing a second media content based on a selection of a target timbre by the user, the second media content comprising a second audio content corresponding to the singing content, and the second audio content corresponding to the selected target timbre.
